(19) United States
(12) Patent Application Publication
(10) Pub. No.: US 2009/0000699 A1
(43) Pub. Date: Jan. 1, 2009

(54) Tree chipper

(76) Inventor: Blair John Savege, Kelowna (CA)

Correspondence Address: Antony C. Edwards, P.O. Box 26020, Westbank, BC, V4T 2G3, CA

(21) Appl. No.: 11/819,374

(22) Filed: Jun. 27, 2007

(51) Int. Cl. A01G 23/083

(52) U.S. Cl. 144/337; 144/24.13; 144/4.1

(57) ABSTRACT

Disclosed is a method and apparatus for chipping a tree utilizing a helicopter suspended chipping apparatus. The chipping apparatus comprises a frame having a bottom, which is suspendable from a support vehicle and includes a chipping rotor having a length extending along a substantially horizontal axis and a chipping surface. The chipping rotor is rotatably mounted in the frame such that a lowermost portion of the chipping surface is proximate to the bottom of said frame. The chipping apparatus further includes a drive motor operably connected to the chipping rotor for rotating the chipping rotor about the substantially horizontal axis. The chipping apparatus may be lowered onto a tree to be chipped by the helicopter so as to chip the tree proximate to ground level.

### FIELD OF THE INVENTION

The present invention relates to chipping trees in general and in particular to a method and apparatus for chipping a standing tree down to proximate to ground level through the use of a helicopter.

### BACKGROUND OF THE INVENTION

Methods and apparatuses for chipping or shredding of trees and other wood products are generally known. Chippers are commonly used to reduce the tree or wood product into smaller pieces, for example chips or sawdust. The chips may be collected for further use such as for use in papermaking or as ground cover.

Many chippers must be towed to a desired location where wood pieces may be fed into the chipper. Other chippers have been mounted to the end of an excavator boom. Such boom mounted chippers may be useful for chipping a free standing tree or portion thereof. Such chippers are limited however to being used in areas with available ground access such as proper roadways.

Infestations of certain tree damaging insects have become problematic in many locations. Infestations of insects such as the mountain pine beetle, for example are known to cause directly or indirectly the death and damage of millions of trees. The death of these trees may result in the loss of millions of dollars to the forest industry as well as an increased local forest fire hazard due to the dead standing trees resulting from these infestations. It is known that in many insect infestations, such as mountain pine beetle for example, the majority of the life cycle of the insect is spent under the bark of the tree with the insect being unable to survive outside of the tree during many stages of development. Thus only the mature insect may move to another tree so as to spread the infestation. Accordingly, one method of controlling such insect infestation outbreaks is to destroy the infected trees before the insects are mature enough to survive outside of the tree.

One manner of destroying an infested tree is to chip or shred the tree. However, previous methods and apparatuses for chipping a standing infested tree have proved unsuitable. As described above, many chippers require road access so that the chipping device may be towed to the appropriate location or the infested tree may be cut down and hauled to the chipper. This method is both expensive in terms of man power and equipment and also impractical for infestations occurring in areas where no road access exists.

Previous attempts to chip a whole standing tree with a helicopter slung chipper, for example as found in U.S. Pat. No. 5,305,972, have also proved inadequate. In particular, the apparatus disclosed in U.S. Pat. No. 5,305,972 is not capable of chipping the entire tree down to proximate to ground level. Due to the aforementioned location of the infesting insect under the bark of the tree, it is necessary to chip substantially the entire tree so as to not leave a viable portion of the trunk with its bark in place.

Other attempts at a helicopter suspended chipping apparatus have included a chipping rotor having a vertical axis of rotation which has also proved unsatisfactory. In particular, the vertically rotating chipper may be prone to become lodged on the tree trunk such that the resulting vertical chipping movement is then transferred to the chipping apparatus or possibly the helicopter. This represents a significant safety risk to the operation of such a chipping apparatus.

What is desirable is a method and apparatus of chipping a standing tree to ground level with a helicopter suspended chipper without the safety implications.

### SUMMARY OF THE INVENTION

What is disclosed is an improved method and apparatus of chipping a standing tree to ground level with a helicopter suspended chipper.

According to a first embodiment of the present invention there is disclosed an apparatus for chipping a tree. The apparatus comprises a frame having a bottom and a chipping rotor having a length extending along a substantially horizontal axis and a chipping surface. The frame is suspendable from a support vehicle wherein the chipping rotor is rotatably mounted in the frame such that a lowermost portion of the chipping surface is proximate to the bottom of the frame. The apparatus further includes a drive motor operably connected to the chipping rotor for rotating the chipping rotor about the horizontal axis.

The apparatus may further comprise at least two guide plates hingedly connected to the frame along axes of rotation parallel to the axis of the rotor so as to extend from the frame. The hinge plates extend from the frame on opposite sides of the rotor at a height above the lowermost portion of the chipping surface wherein the guide plates are angularly supported to form a funnel below a horizontal plane. The guide plates are freely pivotable into the horizontal plane.

The at least two guide plates may each have a width extending from first edges closest to the frame to distal edges distal from the first edges. The width may decrease along a length of the at least two guide plates. The length may be parallel to the first edges. The at least two guide plates may be arranged in at least one oppositely disposed pair of the guide plates on opposite sides of the chipping rotor. The distal edges of each of the pair may be substantially symmetrical about the substantially horizontal axis.

The guide plates may be angularly supported by flexible tension members extending from the frame to the guide plates. The flexible tension members may be selected from the group comprising of a rope, a cable and a chain. The apparatus may further comprise a pair of end plates at opposite ends of the rotor. The end plates may have bottom edges and be freely slidably connected to the frame such that the bottom edge may be slidably displaced to a height above the lowermost portion of the chipping surface.

The apparatus may further comprise a transmission operably connecting the motor and the rotor. The transmission may include a clutch. The clutch may comprise a centrifugal clutch. The transmission may comprise a continuously variable transmission.

The apparatus may further comprise an indicator for indicating to an operator the rotational speed of the chipping rotor. The indicator may comprise a plurality of indicator lights. The indicator may comprise first second and third lights. The first light may be adapted to be illuminated when the chipping rotor is rotated at a speed below a minimum rotational speed for the rotor. The second light may be adapted to be illuminated when the chipping rotor is rotating at a speed above a recommended rotational speed for the chipping rotor. The third light may be adapted to be illuminated when the chipping rotor is rotating at a speed above a minimum rotational speed for the chipping rotor and below a recommended rotational speed for the chipping rotor.

The apparatus may further comprising a housing surrounding the chipping rotor. The housing may comprise a pair of spaced apart side walls aligned with the chipping rotor and a top portion spanning the chipping rotor. At least one of the side walls may include exhaust openings for expelling chips produced by the chipping rotor from the housing. The exhaust openings may include guide flaps extending from a top edge of the exhaust openings. The apparatus may further comprise a pivotable connector for connecting the frame to the support vehicle.

According to a further embodiment of the present invention there is disclosed a method for chipping a tree. The method comprising suspending a chipping apparatus having a bottom from a helicopter and rotating a chipping rotor in the chipping apparatus about a substantially horizontal axis. The chipping rotor has a chipping surface with a lowermost portion disposed adjacent to the bottom of the chipping apparatus. The method further comprises lowering the chipping apparatus down onto a tree such that the chipping rotor chips the tree to a height substantially level with the ground.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a chipping apparatus according to a first embodiment of the present invention suspended above a tree to be chipped by a helicopter.

FIG. 2 is a top perspective view of the chipping apparatus of FIG. 1.

FIG. 3 is a partially exploded bottom perspective view of the chipping apparatus of FIG. 1.

FIG. 4 is a cross-sectional view of the chipping apparatus as taken along the line 4-4 of FIG. 2.

FIG. 5 is a perspective view of the transmission assembly, motor and chipping rotor of the chipping apparatus of FIG. 1 with the frame and housing removed.

FIG. 6 is a cross-sectional view of the continuously variable transmission assembly as taken along the line 6-6 of FIG. 5.

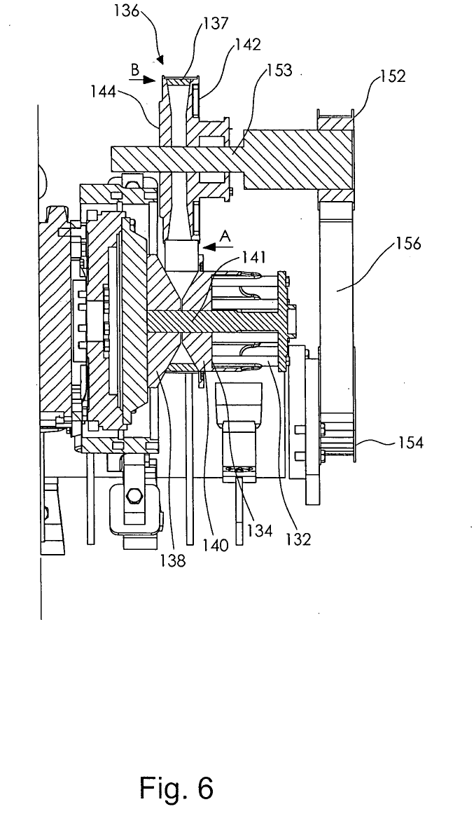

FIG. 7 is a top perspective view of a chipping apparatus according to a further embodiment having a fixed ratio drive transmission.

### DETAILED DESCRIPTION OF EMBODIMENTS OF THE INVENTION

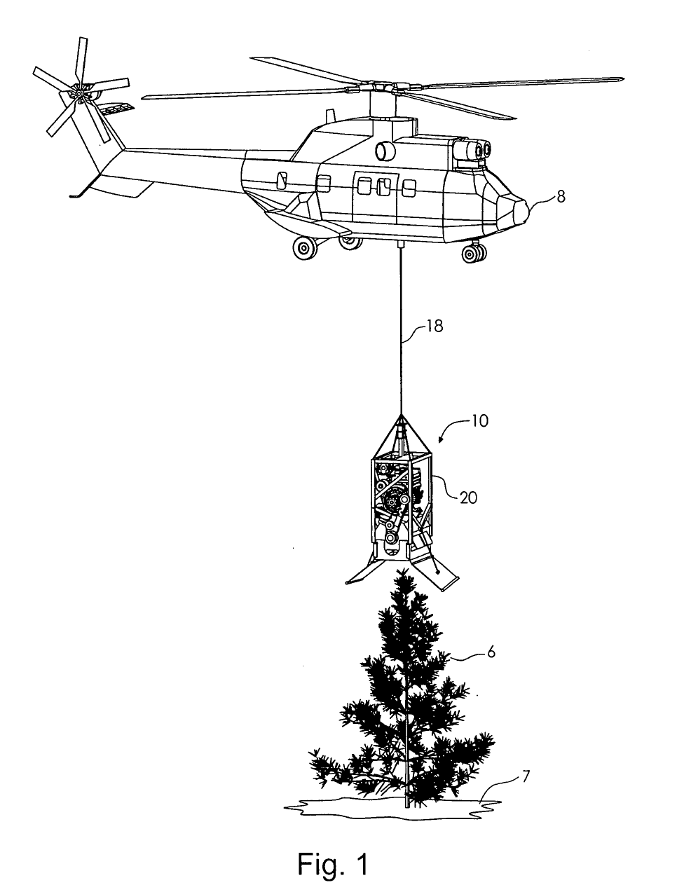

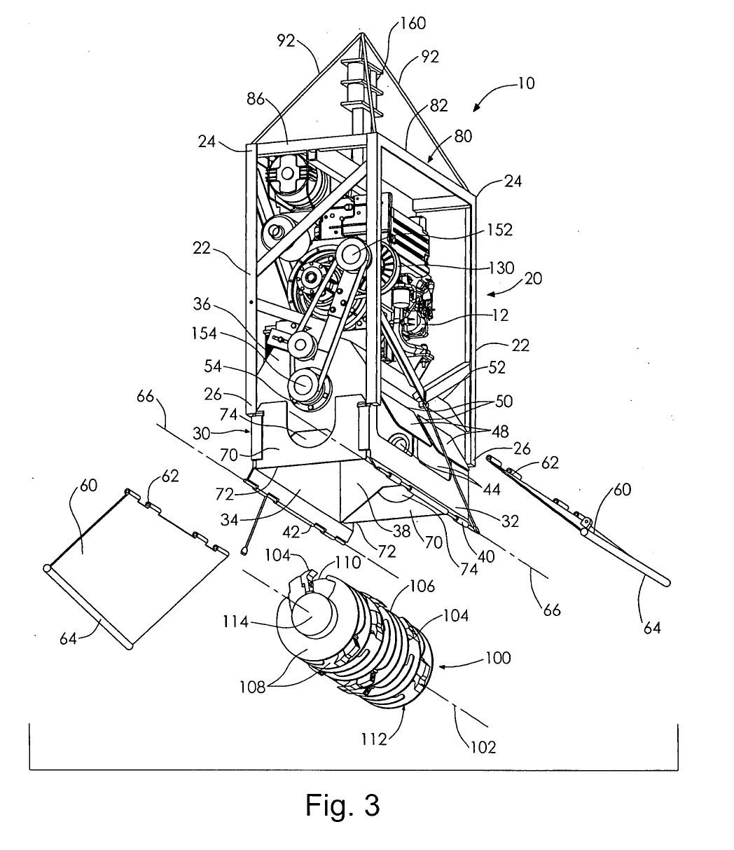

Referring to FIG. 1, an apparatus for chipping a tree 6 according to a first embodiment of the invention is shown generally at 10. The apparatus comprises a chipping rotor 100, a motor 12 and a frame 20. The frame is suspended from a helicopter 8 by a cable 18 or other suitable suspension means. The motor 12 and chipping rotor 100 better seen in FIG. 3 are supported by the frame 20 while the motor drives the chipping rotor 100. As the apparatus 10 is lowered down onto a tree 6, the chipping rotor chips the tree to a ground level generally indicated at 7. It will also be appreciated that although the current chipping apparatus is described as being slung from a helicopter, the chipping apparatus 10 may also be supported from a crane or truck boom for chipping trees in locations where road access exists.

The motor 12 comprises an internal combustion engine and in particular air cooled diesel motors have been shown to be useful. It will be appreciated however that other types of internal combustion engines as well as electric motors, pneumatic and hydraulic motors may also be useful.

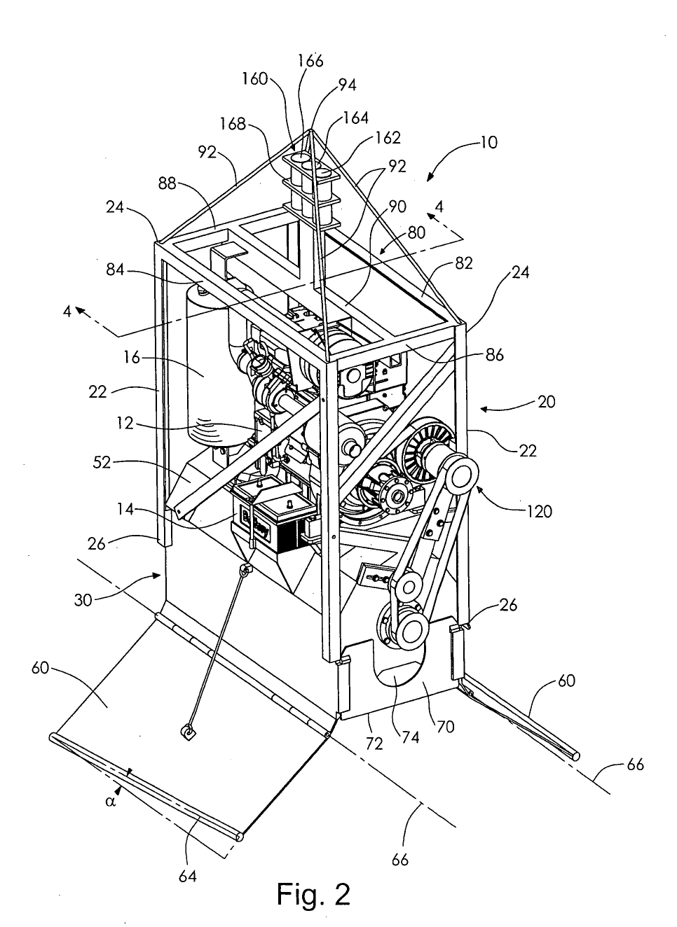

Turning now to FIG. 2, the frame comprises a cuboid space frame having four spaced apart corner uprights 22 each having upper and lower portions 24 and 26, respectively. The upper portions 24 of the uprights 22 are connected by a top frame 80 while the bottom portions 26 are connected by a rotor housing 30 which contains and supports the chipping rotor 100 therein.

Returning now to FIG. 3, a partially exploded perspective bottom view of the chipping apparatus 10 is illustrated with the chipping rotor 100 and guide plates 60, as described below, removed from the housing 30. The chipping rotor 100 comprises an elongate cylindrical body having an axis of rotation 102. Rotor shaft 114 rotates about axis 102. A plurality of radially and longitudinally extending chipping knives 104 are distributed along an exterior surface 106 of the chipping rotor 100. As illustrated, the chipping rotor 100 is shown as having a plurality of longitudinally spaced annular flange plates 108 each of which includes a chipping knife 104 and an associated chip opening 110. It will be appreciated however, that other types of horizontally rotating drum-style chipping rotors will also be useful. The exterior surface 106 of the chipping rotor 100 includes a bottom portion 112 which remains at the bottommost portion of the chipping rotor as it is rotated about axis 102.

The housing comprises first and second parallel spaced apart side plates 32 and 34, respectively and first and second parallel spaced apart end plates 36 and 38, respectively. The first and second side plates 32 and 34 have bottom edges 40 and 42, respectively positioned at a height level with or above the bottom portion 112 of the chipping rotor 100. The first and second side plates 32 and 34 extend parallel to the chipping rotor 100. The first and second end plates 36 and 38 each support rotor bearings 54 which rotatably support the rotor shaft 114 of the chipping rotor 100 therebetween. A secondary transfer pulley 154 as further described below is connected to the rotor shaft 114 on an opposite side of the first end plate 36 from the chipping rotor 100 and drives the chipping rotor from the motor 12. The first side plate 32 includes a pair of chip exhaust openings 44. The chip exhaust openings 44 comprise a pair of spaced apart rectangular passages through the first side plate 32. The chip exhaust openings 44 include deflectors 48 connected to top edges 50 of the openings. The deflectors 48 extend downwardly from the top edge 50 to the exterior of the housing 30 and serve to reduce the distance that chips produced by the chipping rotor 100 are expelled from the chipping apparatus 10.

The housing also includes a top portion 52 spanning the first and second side plates 32 and 34 above the chipping rotor 100. The top portion 52 may comprise an arched plate or a plurality of adjoining plates angularly offset from each other to form a segmented arch. As illustrated the top portion may also support the motor 12, a battery 14 and a fuel tank 16 for the motor. It will also be appreciated that separate frame members between the uprights 22 may also be included for supporting the motor 12, battery 14 and fuel tank 16.

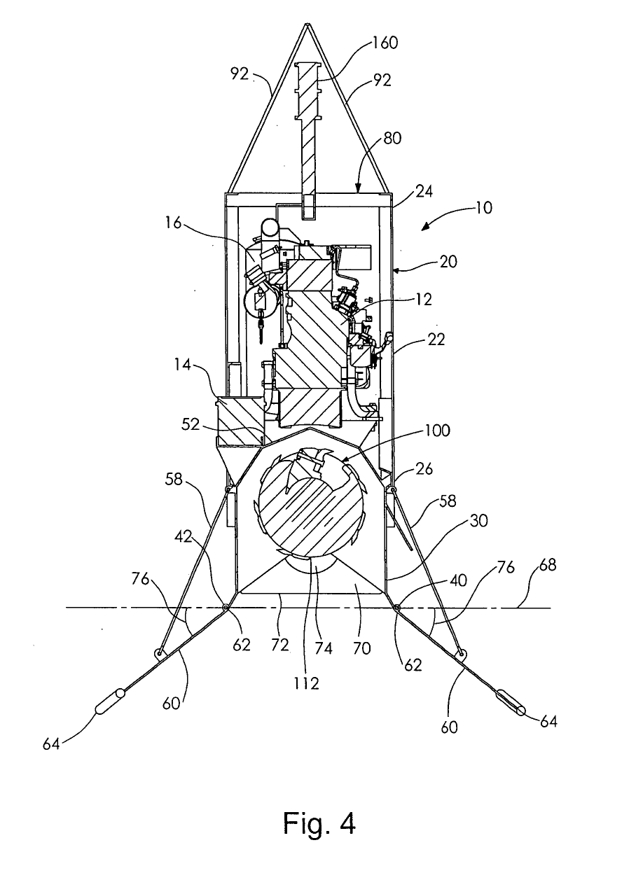

The housing also includes guide plates 60 hingedly connected to the bottom edges 40 and 42 of the first and second side plates through axes 66. Axes 66 define a horizontal plane generally indicated at 68 as illustrated in FIG. 4. Turning to FIG. 4, the guide plates 60 may be oriented at angles indicated at 76 below the horizontal plane 68. As illustrated, the guide plates 60 may be oriented at an angle below the horizontal plane 68 however it will be appreciated that the guide plates may also be oriented above the horizontal plane.

The guide plates 60 have proximate and distal ends 62 and 64, respectively and extend from the side plates at an adjustable angle thereto. The distal ends 64 of guide plates 62 are angularly oriented relative to the axes 66 by an angle generally indicated at a. As illustrated, the distal ends 64 are oriented at equivalent angles but opposite directions to each other. Accordingly, when either of the distal ends 64 encounter an obstacle, such as a branch, for example, the angular orientation of the distal end will impart a rotation to the chipping apparatus 10 so as to move the obstacle to one of the sliding end plates 70. As illustrated in FIG. 2 the angles a of the distal ends 64 will cause the chipping apparatus to rotate in a vertical clockwise direction when viewed from above in response to contacting a branch. It will be appreciated however that a counter-clockwise rotation may also be useful.

The guide plates 60 are adapted to have a lowermost orientation at which the guide plates are at a maximum angle of declination below the horizontal plane 68. The guide plates 60 are supported at their lowermost orientation by tension wires 58. The guide plates 60 may be freely rotated upwardly from their lowermost positions upon contact of the distal ends 64 of the guide plates 60 upon the ground 7. It will be observed that through rotation of the guide plates 60 upwards from their lowermost positions will serve to enable the guide plates to rest horizontally on the ground 7 when the distal ends 64 are rested on the ground. It will be appreciated that although tension wires 58 are used in the current illustration for supporting the guide plates, cables, chains or other suitable flexible tension members will also be useful.

Referring back to FIG. 2, the housing also includes sliding end plates 70 slidingly mounted to the end plates 36 and 38. The sliding end plates 70 include ground engaging bottom edges 72 and notched openings 74 for receiving the bearings 54 therein. The sliding end plates 70 are ridable to a lowermost position and may be slidingly raised upon engagement of the bottom edges 72 upon the ground 7. As the chipping apparatus 10 is further lowered relative to the ground 7 the sliding plates are maintained at a constant position relative to the ground 7 until the bottom edges are coplanar with the bottom edges 40 and 42 of the side plates 32 and 34. As the sliding end plates 70 are raised relative to the chipping apparatus 10, the notched openings 74 surrounds the bearing 54.

The top frame 80 comprises first and second side beams 82 and 84, respectively and first and second end beams 86 and 88, respectively. The first and second side beams 82 and 84 are parallel to and spaced above the side plates 32 and 34. The first and second end beams 86 and 88 are parallel to and spaced above the first and second end plates 36 and 38. The top frame 80 may also include a centre beam 90. A support wire 92 extends from the each upper portion 24 of each upright 22 to a common connector 94 for connection to cable 18.

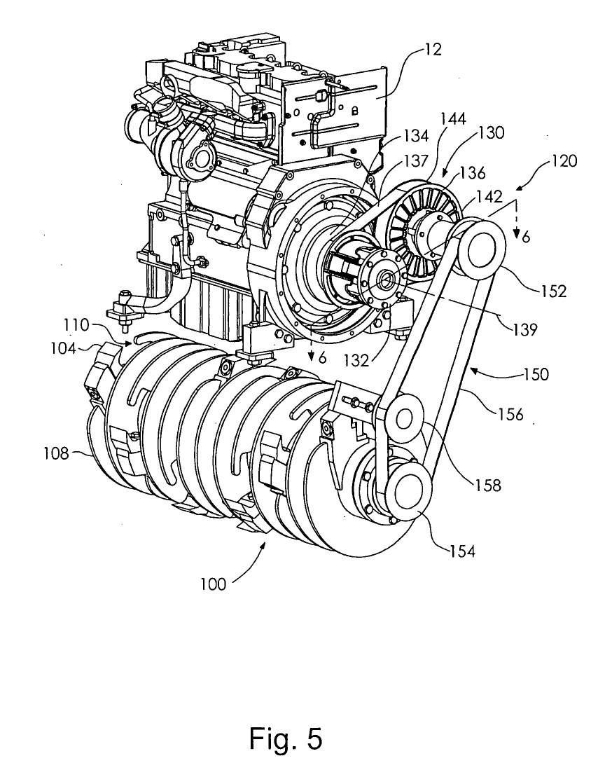

The chipping rotor 100 is driven by the motor 12. A transmission assembly 120 is included between the chipping rotor and the motor for transmitting torque between the motor 12 and the chipping rotor 100. Referring to FIG. 5 a detailed view of the transmission assembly 120, motor 12 and chipping rotor 100 is shown with the frame removed. The transmission assembly 120 includes a continuously variable transmission assembly 130 and a transfer belt assembly 150. In the illustrated embodiment, the continuously variable transmission assembly 130 may be a snowmobile-type continuously variable transmission or endless-belt transmission. The continuously variable transmission includes a clutch 132 and primary and secondary variable pulleys 134 and 136, respectively and a variable drive belt 137 therebetween. The primary variable pulley 134 and the clutch 132 are connected coaxially with a drive output shaft of the motor along a primary drive axis 139. The primary variable pulley 134 comprises stationary and moveable primary variable pulley halves 138 and 140, respectively. The moveable primary variable pulley half 138 has a free position spaced apart along a drive axis 139 from the stationary primary variable pulley half 140. The clutch 132 urges the moveable primary variable pulley half 138 towards the stationary primary variable pulley half 140 half in response to an increase in rotational speed of the common motor output shaft, clutch 132 and primary variable pulley 134.

The secondary variable pulley 136 comprises stationary and moveable secondary variable pulley halves 142 and 144, respectively. The moveable secondary variable pulley half 142 has an initial position proximate to the stationary secondary variable driven pulley half 144. A torque sensing means, such as for example a sprung cam (not shown) urges the moveable secondary variable pulley half 142 away from the stationary secondary variable pulley half 144 in response to a greater resistive load on the secondary variable pulley 134 such as for example due to a larger tree 6 being chipped or being fed into the chipping apparatus at a greater rate.

The transfer belt assembly 150 comprises a primary transfer pulley 152, a secondary transfer pulley 154 and a transfer belt 156. The primary transfer pulley 152 is coaxially mounted on a transfer shaft 153 with the secondary variable pulley 136. The secondary transfer pulley 154 is coaxially connected to the shaft 114 of the chipping rotor 100. The transfer belt assembly 150 also includes a belt tensioner 158 adapted to ensure an adequate tension in the transfer belt 156. The primary and secondary transfer pulleys 152 and 154 may have diameters selected to provide a speed reduction between the motor 12 and the chipping rotor 100. It will also be appreciated in certain embodiments, that the secondary variable pulley 136 may be directly connected to the shaft 114 of the chipping rotor 100.

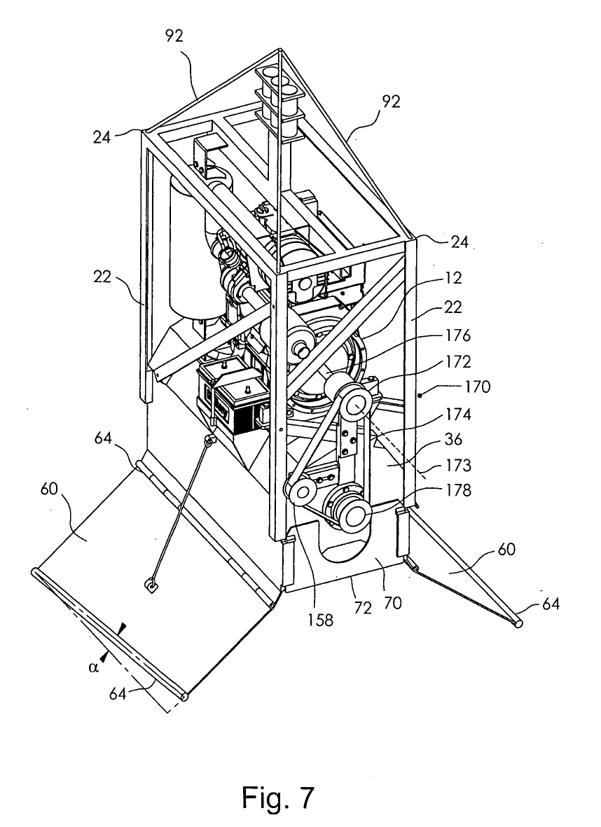

Turning now to FIG. 7, a further embodiment of the present invention is shown having a fixed drive transmission 170. The fixed drive transmission 170 comprises a motor pulley 172 mounted co-axially to the motor output shaft 176 along axis 173 chipping rotor pulley 178, and belt tensioner 158. Drive belt 174 transfers the rotation of the motor pulley 172 to the chipping rotor pulley 178 according to a fixed ratio.

Turning back to FIG. 2, the chipping apparatus 10 also includes an indicator system indicated generally at 160. The indicator system comprises a plurality of indicator lights 162, 164 and 166 mounted within an indicator assembly 168 on the top frame 80. The indicator lights 162, 164 and 166 are selected from the colours red, amber and green and are oriented towards the helicopter 8 such that they are viewable by an operator within the helicopter. The red amber and green indicator lights 162, 164 and 166 are adapted to cooperate with a speed sensor (not shown) which measures the rotational speed of the chipping rotor 100. The red indicator light 162 is adapted to be illuminated when the chipping rotor 100 is rotating below a minimum speed. The green indicator light 164 is adapted to be illuminated when the chipping rotor 100 is rotating above a preferred speed and the amber indicator light 166 is adapted to be illuminated when the chipping rotor 100 is rotating between the preferred and minimum speeds.

The speeds selected as the preferred and minimum speed are selected based upon the particular chipping rotor 100, motor 12 and transmission assembly 120 utilized. The preferred speed should be selected so as to be less than the maximum recommended speed for the chipping rotor 100 and above the minimum speed. The minimum speed should be selected to be above the minimum speed at which the chipping rotor 100 will effectively chip a tree 6. Examples of such typical chipping rotors will typically not effectively work at speeds below 1200 rpm, by way of non limiting example. In addition the maximum speed of the chipping rotor must be below the load and speed requirements for the bearings. The preferred speed must also be selected so as to be below the maximum speed at which the motor and transmission assembly are capable of rotating the chipping rotor. In the embodiment illustrated in which the motor is an air cooled diesel motor and the chipping rotor is a drum chipping rotor having a diameter of approximately 18 inches in diameter a plurality of bolted on chipping knives are preferred and minimum speeds of 2800 rpm and 1600 rpm, respectively have been utilized. However, for other combinations of motors and chipping rotors, other speeds will also be useful.

### Operation

In operation, a helicopter 8 suspending the chipping apparatus 10 positions the chipping apparatus over a tree 6 to be chipped. The motor 12 rotates the chipping rotor 100 through the transmission assembly 120. As the chipping apparatus 10 is lowered onto the tree 6 the chipping rotor 100 reduces the portion of the tree in contact with the chipping rotor to chips which are expelled through the exhaust openings 44 and distributed on the ground 7. Through controlling the rate of descent of the helicopter 8 the operator may control the rate of descent of the chipping apparatus 10 upon the tree 6 and thereby the chipping rate and load on the chipping apparatus.

When the motor 12 is started, the centrifugal clutch 132 is engaged and urges the moveable primary variable pulley half 140 towards the stationary primary variable pulley half 138 as indicated by arrow A. As the moveable and stationary primary variable pulley halves 140 and 138 are moved together, they engage between them the drive belt 137 which thereafter rotates the secondary variable pulley 136 in proportion to the current drive ratio therebetween. The secondary variable pulley drives the primary transfer pulley 152 through their common shaft which in turn drives the secondary transfer pulley 154 on the shaft 114 of the chipping rotor 100 through the transfer belt 156. As a load is applied to the chipping rotor 100 through increased feed rates of the tree 6 into the chipping rotor 100, the load at the secondary variable pulley 136 will cause the torque sensing means to move the moveable secondary variable pulley half 144 towards the stationary secondary pulley half 142 as indicated by arrow B. This will cause the drive belt 137 to engage the secondary variable pulley 136 at a greater radius. Concurrently, the increased radius of the secondary variable pulley 136 will urge the drive belt 137 further into the space between the moveable and secondary primary variable pulleys halves 142 and 144 thereby urging them apart and reducing the drive ratio of the continuously variable transmission assembly 130 and applying a greater torque output to overcome the increased resistance at the chipping rotor 100. The chipping rotor 100 will also reduce its rotational speed in response to this increased load. When the load is reduced at the chipping rotor 100, the above process will be reduced and the speed of the chipping rotor will increase.

It will be appreciated that the above description of a variable speed drive will not apply where a fixed drive transmission is utilized as described above and illustrated in FIG. 7. Where a fixed drive transmission is used, however, the chipping rotor 100, and correspondingly the motor 12 may still slow down in respond to increased resistance on the chipping rotor from the tree. For such an arrangement, it has been found that the preferred speed and minimum speed of 2800 rpm and 1600 rpm respectively have been useful to prevent unwanted stalling of the motor 12.

The operator of the chipping apparatus, who may also be the operator of the helicopter observes the indicator lights 162, 164 and 166 to ensure that the chipping rotor 100 is rotating above the minimum required speed. If the amber indicator light 166 is illuminated, the operator may slow the rate of descent of the chipping apparatus 10 upon the tree 6 so as to reduce the feed rate of the tree into the chipping rotor 100. If the red indicator light 162 is illuminated, the operator may further slow or stop the rate of descent of the helicopter 8 or may raise the helicopter so as to reduce the resistive load on the chipping rotor 100 until the rotational speed of the chipping rotor increases to an acceptable rate. When the green light is illuminated the operator may resume lowering the chipping apparatus 10 onto the tree 6.

As the chipping apparatus 10 is lowered proximate to a bottom portion of a tree 6, the distal ends 64 of the guide plates 60 engage upon the ground 7. As the chipping apparatus 10 is lowered further, the ground 7 rotates the guide plates 60 upwardly away from the lowermost position until the guide plates 60 are level with the ground 7 and the bottom edges 40 of the side plates 32 and 34 are resting on the ground. Concurrently, the bottom edges 72 of the sliding end plates 70 will similarly engage the ground 7 and be slidably displaced upward relative to the chipping apparatus 10. The displacement of the guide plates 60 and the sliding end plates 70 will enable the bottom edges 40 and 42 of the side plates 32 and 34 which represent the bottom of the frame 20 to rest upon the ground 7. In this position, the bottom portion 112 of the chipping rotor 100 will be substantially level with the ground and will therefore chip the entire tree to ground level.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. An apparatus for chipping a tree, the apparatus comprising:
a frame having a bottom, said frame being suspendable from a support vehicle;
a chipping rotor having a length extending along a substantially horizontal axis and a chipping surface, said chipping rotor being rotatably mounted in said frame such that a lowermost portion of said chipping surface is proximate to said bottom of said frame; and
a drive motor operably connected to said chipping rotor for rotating said chipping rotor about said horizontal axis.

2. The apparatus of claim 1 further comprising at least two guide plates hinged to said frame along axes of rotation parallel to said axis of said rotor so as to extend from said frame, said plates hinged to said frame on opposite sides of said rotor at a height above said lowermost portion of said chipping surface wherein said guide plates are angularly supported to form a funnel below a horizontal plane, said guide plates being freely pivotable into said horizontal plane.

3. The apparatus of claim 2 wherein said at least two guide plates each have a width extending from first edges closest to said frame to distal edges distal from said first edges, and wherein said width decreases along a length of said at least two guide plates, said length parallel to said first edges.

4. The apparatus of claim 3 wherein said at least two guide plates are arranged in at least one oppositely disposed pair of said guide plates on opposite sides of said chipping rotor, wherein said distal edges of each said pair are substantially symmetrical about said substantially horizontal axis.

5. The apparatus of claim 2 wherein said guide plates are said angularly supported by flexible tension members extending from said frame to said guide plates.

6. The apparatus of claim 5 wherein said flexible tension members are selected from the group comprising a rope, a cable and a chain.

7. The apparatus of claim 1 further comprising a pair of end plates at opposite ends of said rotor, wherein said pair of end plates have bottom edges and are freely slidably connected to said frame such that said bottom edges are slidably displaceable to a height above said lowermost portion of said chipping surface

8. The apparatus of claim 1 further comprising a drive transmission operably connecting said motor and said rotor.

9. The apparatus of claim 8 wherein said transmission includes a clutch.

10. The apparatus of claim 8 wherein said transmission comprises a continuously variable transmission.

11. The apparatus of claim 1 further comprising an indicator for indicating to an operator the rotational speed of said chipping rotor.

12. The apparatus of claim 11 wherein said indicator comprises a plurality of indicator lights.

13. The apparatus of claim 12 including a first light adapted to be illuminated when said chipping rotor is rotated at a speed below a minimum rotational speed for said chipping rotor.

14. The apparatus of claim 12 including a second light adapted to be illuminated when said chipping rotor is rotating at a speed above a recommended rotational speed for said chipping rotor.

15. The apparatus of claim 12 including a third light adapted to be illuminated when said chipping rotor is rotating at a speed above a minimum rotational speed for said chipping rotor and below a recommended rotational speed for said chipping rotor.

16. The apparatus of claim 12 wherein said indicator lights are selected from the group consisting of red amber and green.

17. The apparatus of claim 1 further comprising a housing surrounding said chipping rotor.

18. The apparatus of claim 17 wherein said housing comprises a pair of spaced apart side walls aligned with said chipping rotor and a top portion spanning said chipping rotor.

19. The apparatus of claim 18 wherein at least one of said side walls includes exhaust openings for expelling chips produced by said chipping rotor from said housing.

20. The apparatus of claim 19 wherein said exhaust openings include guide flaps extending from a top edge of said exhaust openings.

21. The apparatus of claim 1 further comprising a pivotable connection for connecting said frame to said support vehicle.

22. A method for chipping a tree, the method comprising:
suspending a chipping apparatus having a bottom from a support vehicle;
rotating a chipping rotor in said chipping apparatus about a substantially horizontal axis wherein said chipping rotor has a chipping surface with a lowermost portion disposed adjacent to said bottom of said chipping apparatus; and
lowering the chipping apparatus down onto a tree such that said rotor chips the tree to height proximate the ground.
